(19) United States
(12) Patent Application Publication
(10) Pub. No.: US 2013/0154910 A1
(43) Pub. Date: Jun. 20, 2013

(54) DISPLAY PANEL

(71) Applicants: Shang-Chieh Chu, Taoyuan County (TW); Hsueh-Yen Yang, Taoyuan County (TW); Hong-Shen Lin, Miaoli County (TW)

(72) Inventors: Shang-Chieh Chu, Taoyuan County (TW); Hsueh-Yen Yang, Taoyuan County (TW); Hong-Shen Lin, Miaoli County (TW)

(73) Assignee: AU OPTRONICS CORPORATION, Hsinchu (TW)

(21) Appl. No.: 13/476,023

(22) Filed: May 21, 2012

(30) Foreign Application Priority Data
Dec. 16, 2011 (TW) 100146876

(51) Int. Cl. G09G 3/32

(52) U.S. Cl. 345/83

(57) ABSTRACT

A display panel has a pixel array arranged with a plurality of columns and a plurality of rows. The display panel includes a first pixel group and a second pixel group arranged in the first row and adjacent to each other. The first pixel group and the second pixel group respectively include a first color sub-pixel, a second color sub-pixel, a third color sub-pixel, and a transparent sub-pixel. The arrangement of the first color sub-pixel, the second color sub-pixel, the third color sub-pixel, and the transparent sub-pixel of the first pixel group and the arrangement of the first color sub-pixel, the second color sub-pixel, the third color sub-pixel, and the transparent sub-pixel of the second pixel group are symmetric in mirror.

### CROSS-REFERENCE TO RELATED APPLICATION

This application claims the priority benefit of Taiwan application serial no. 100146876, filed on Dec. 16, 2011. The entirety of the above-mentioned patent application is hereby incorporated by reference herein and made a part of this specification.

### BACKGROUND OF THE INVENTION

1. Field of the Invention

The invention relates to a display panel. More particularly, the invention relates to a transparent display panel.

2. Description of Related Art

The information and communication industries have become dominant industries in our society. In particular, the development of portable communication and display devices has become the focus of attention. Since a flat panel display provides a man-machine interface for information exchange, the development of the flat panel display is rather important. For instance, an organic light emitting display is an organic light emitting apparatus that has a tremendous potential to become a mainstream of the next generation flat panel display due to its advantages of self-luminescence, wide viewing-angle, economic power consumption, simple manufacturing process, low costs, low working temperature, high response speed, full-color display, and so on.

Technology of a transparent display panel is also in progress. The transparent display panel refers to a display panel that has certain transmittance and is able to clearly display background behind the display panel. The transparent display is applicable to windows of buildings, car windows, shop display windows, and so on. Since the transparent display is not only able to display the background behind the display panel but also likely to act as an information display in the near future, the transparent display has attracted great attention.

The existing organic light emitting display panels are mostly capable of displaying images but are not equipped with transmittance properties. U.S. Pat. No. 7,250,930 discloses formation of a transparent thin film transistor (TFT) to enhance transmittance of a display panel. Since the TFT occupies a small area, the TFT is not very helpful to improve the transmittance of the display panel. US publication no. 20090321728 discloses using indium tin oxide as a material of a cathode and an anode. Said design indeed increases transparency of the display panel, whereas the indium tin oxide formed on an organic light emitting material is apt to cause damages to the organic light emitting material.

### SUMMARY OF THE INVENTION

The invention provides a display panel which can resolve an issue of insufficient transmittance of a conventional transparent display panel or reduce the likelihood of causing damages to other film layers.

In the invention, a display panel having a pixel array arranged with a plurality of columns and a plurality of rows is provided. The columns are arranged along an X direction, and the rows are arranged along a Y direction. Alternatively, the columns are arranged along the Y direction, and the rows are arranged along the X direction. The display panel includes a first pixel group and a second pixel group which are arranged in the first row and adjacent to each other. Each of the first pixel group and the second pixel group respectively includes a first color sub-pixel, a second color sub-pixel, a third color sub-pixel, and a transparent sub-pixel. The arrangement of the first color sub-pixel, the second color sub-pixel, the third color sub-pixel, and the transparent sub-pixel of the first pixel group and the arrangement of the first color sub-pixel, the second color sub-pixel, the third color sub-pixel, and the transparent sub-pixel of the second pixel group are symmetric in mirror.

In the invention, a display panel including a plurality of first pixel groups and a plurality of second pixel groups is provided. Each of the first pixel groups includes a first color sub-pixel, a second color sub-pixel, and a third color sub-pixel. Each of the second pixel groups includes a first transparent sub-pixel, a second transparent sub-pixel, and a third transparent sub-pixel. The first pixel groups and the second pixel groups are arranged in a checkerboard-shaped manner.

In the invention, a display panel having a pixel array arranged with a plurality of columns and a plurality of rows is provided. The columns are arranged along an X direction, and the rows are arranged along a Y direction. Alternatively, the columns are arranged along the Y direction, and the rows are arranged along the X direction. The display panel includes a first pixel group and a second pixel group which are arranged in the first row and adjacent to each other. The first pixel group includes a first transparent sub-pixel, a second color sub-pixel, and a second transparent sub-pixel. The second pixel group includes a first color sub-pixel, a transparent sub-pixel, and a third color sub-pixel.

In the invention, a display panel having a pixel array arranged with a plurality of columns and a plurality of rows is provided. The columns are arranged along an X direction, and the rows are arranged along a Y direction. Alternatively, the columns are arranged along the Y direction, and the rows are arranged along the X direction. The display panel includes a first pixel group, a second pixel group, and a third pixel group. The first pixel group is arranged in the first row and includes a first color sub-pixel, a second color sub-pixel, and a transparent sub-pixel. The second pixel group is adjacent to the first pixel group and arranged in the second row. Besides, the second pixel group includes a first color sub-pixel, a transparent sub-pixel, and a third color sub-pixel. The third pixel group is adjacent to the second pixel group and arranged in the third row. Besides, the third pixel group includes a transparent sub-pixel, a second color sub-pixel, and a third color sub-pixel.

Based on the above, the design of the transparent sub-pixel allows the display panel to have the transmittance properties when the display panel is off. The first, second, and third color sub-pixels of the display panel serve to display images, and the transparent sub-pixel mainly serves to ensure transparency of the display panel. Hence, the display panel of the invention can have optimal display quality and can have certain transparency.

In order to make the aforementioned and other features and advantages of the invention more comprehensible, embodiments accompanying figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 to FIG. 6 are schematic views illustrating a display panel according to several embodiments of the invention.

### DESCRIPTION OF EMBODIMENTS

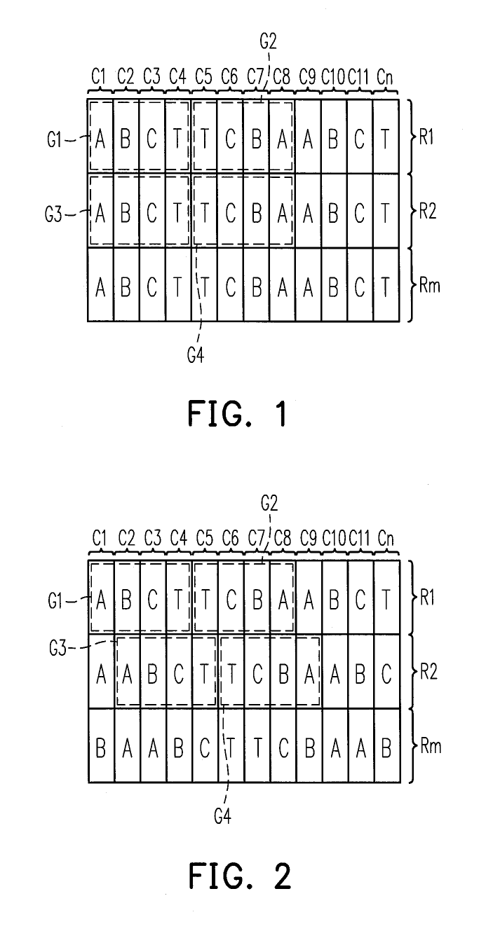

FIG. 1 is a schematic view illustrating a display panel according to an embodiment of the invention. With reference to FIG. 1, the display panel of this embodiment includes a pixel array arranged with a plurality of columns C1˜Cn and a plurality of rows R1˜Rm. As shown in FIG. 1, the columns C1˜Cn are arranged in an X direction, while the rows R1˜Rm are arranged in a Y direction. Hence, the columns C1˜Cn may be referred to as vertical columns, while the rows R1˜Rm may be referred to as horizontal rows. However, the invention is not limited thereto. According to another embodiment of the invention, the columns C1˜Cn are arranged in the Y direction, while the rows R1˜Rm are arranged in the X direction. That is to say, the columns C1˜Cn and the rows R1˜Rm described herein mainly serve to explain relative positions of arrays but do not serve to limit the invention. Hence, the positions of the columns C1˜Cn and the rows R1˜Rm may be exchanged. Besides, when the positions of the columns C1˜Cn and the rows R1˜Rm shown in FIG. 1 are exchanged, the new array arrangement refers to the old arrangement rotated by 90 degrees.

Based on the above, the display panel includes a first pixel group G1 and a second pixel group G2 which are arranged in the first row R1 and are adjacent to each other. Each of the first pixel group G1 and the second pixel group G2 respectively includes a first color sub-pixel A, a second color sub-pixel B, a third color sub-pixel C, and a transparent sub-pixel T. According to this embodiment, the first color sub-pixel A, the second color sub-pixel B, and the third color sub-pixel C are a red color sub-pixel, a green color sub-pixel, and a blue color sub-pixel, respectively, which should however not be construed as a limitation to the invention. Namely, the first color sub-pixel A, the second color sub-pixel B, and the third color sub-pixel C may be a blue color sub-pixel, a red color sub-pixel, and a green color sub-pixel, respectively.

If the display panel described herein is an organic electroluminescent display panel, each of the first color sub-pixel A, the second color sub-pixel B, and the third color sub-pixel C is respectively a sub-pixel structure of the organic electroluminescent display that includes a scan line, a data line, a power line, active devices, a cathode layer, an organic light emitting layer, an anode layer, and so on. If the display panel described herein is an electrophoretic display panel, each of the first color sub-pixel A, the second color sub-pixel B, and the third color sub-pixel C is respectively a sub-pixel structure of the electrophoretic display panel that includes a scan line, a data line, an active device, a pixel electrode, an electrophoretic display layer, an opposite electrode, and so on. As described above, the type of the display panel is not limited in the invention, and therefore the first, second, and third sub-pixel structures may be adjusted based on the type of the display panel.

In comparison with the first, second, and third sub-pixels A, B, and C, the transparent sub-pixel T is not equipped with any display device. Therefore, the transparent sub-pixel T may have metal circuits or conductive wires to transmit driving signals to the first, second, and third sub-pixels A, B, and C; alternatively, the transparent sub-pixel T may have no circuit, which should not be construed as a limitation to the invention. Since there is no display device in the transparent sub-pixel T, the transparent sub-pixel T has great transparency or transmittance properties. As described above, each of the first pixel group G1 and the second pixel group G2 in the display panel of this embodiment has the transparent sub-pixel T. When the display panel is off, the transparent sub-pixel T may ensure transparency of the display panel, such that a user is able to observe the background image behind the display panel.

According to this embodiment, the first color sub-pixel A, the second color sub-pixel B, the third color sub-pixel C, and the transparent sub-pixel T of the first pixel group G1 are respectively configured in the first column C1 and the first row R1, in the second column C2 and the first row R1, in the third column C3 and the first row R1, and in the fourth column C4 and the first row R1. The first color sub-pixel A, the second color sub-pixel B, the third color sub-pixel C, and the transparent sub-pixel T of the second pixel group G2 are respectively configured in the eighth column C8 and the first row R1, in the seventh column C7 and the first row R1, in the sixth column C6 and the first row R1, and in the fifth column C5 and the first row R1. Besides, according to the present embodiment, the arrangement of the first color sub-pixel A, the second color sub-pixel B, the third color sub-pixel C, and the transparent sub-pixel T of the first pixel group G1 and the arrangement of the first color sub-pixel A, the second color sub-pixel B, the third color sub-pixel C, and the transparent sub-pixel T of the second pixel group G2 are symmetric in mirror. For instance, the sub-pixels of the first pixel group G1 are arranged as ABCT, while the sub-pixels of the second pixel group G2 are arranged as TCBA. Since the arrangement of the sub-pixels of the first pixel group G1 and the arrangement of the sub-pixels of the second pixel group G2 are symmetric in mirror, the transparent sub-pixel T of the first pixel group G1 and the transparent sub-pixel T of the second pixel group G2 are adjacent to each other.

In the present embodiment, the display panel further includes a third pixel group G3 and a fourth pixel group G4 which are arranged in the second row R2. Each of the third pixel group G3 and the fourth pixel group G4 respectively includes a first color sub-pixel A, a second color sub-pixel B, a third color sub-pixel C, and a transparent sub-pixel T. According to this embodiment, the first color sub-pixel A, the second color sub-pixel B, the third color sub-pixel C, and the transparent sub-pixel T of the third pixel group G3 are respectively configured in the first column C1 and the second row R2, in the second column C2 and the second row R2, in the third column C3 and the second row R2, and in the fourth column C4 and the second row R2. The first color sub-pixel A, the second color sub-pixel B, the third color sub-pixel C, and the transparent sub-pixel T of the fourth pixel group G4 are respectively configured in the eighth column C8 and the second row R2, in the seventh column C7 and the second row R2, in the sixth column C6 and the second row R2, and in the fifth column C5 and the second row R2. Besides, according to the present embodiment, the arrangement of the first color sub-pixel A, the second color sub-pixel B, the third color sub-pixel C, and the transparent sub-pixel T of the third pixel group G3 and the arrangement of the first color sub-pixel A, the second color sub-pixel B, the third color sub-pixel C, and the transparent sub-pixel T of the fourth pixel group G4 are symmetric in mirror. For instance, the sub-pixels of the third pixel group G3 are arranged as ABCT, while the sub-pixels of the fourth pixel group G4 are arranged as TCBA. Since the arrangement of the sub-pixels of the third pixel group G3 and the arrangement of the sub-pixels of the fourth pixel group G4 are symmetric in mirror, the transparent sub-pixel T of the third pixel group G3 and the transparent sub-pixel T of the fourth pixel group G4 are adjacent to each other.

According to the present embodiment, the transparent sub-pixel T of the first pixel group G1 and the transparent sub-pixel G of the third pixel group G3 are arranged in the same column (the fourth column C4), and the transparent sub-pixel T of the second pixel group G2 and the transparent sub-pixel T of the fourth pixel group G4 are arranged in the same column (the fifth column C5). Hence, the transparent sub-pixels T of the first, second, third, and fourth pixel groups G1˜G4 are gathered together, i.e., the transmittance areas (the transparent areas) of the display panel are gathered together, which means that the arrangement of the sub-pixels can further enhance transparency of the display panel according to the present embodiment.

FIG. 2 is a schematic view illustrating a display panel according to an embodiment of the invention. The embodiment shown in FIG. 2 is similar to the embodiment shown in FIG. 1, and therefore identical components in FIG. 1 and FIG. 2 will be denoted with the same numerals and will not be further described hereinafter.

As shown in FIG. 2, the columns C1˜Cn are arranged in an X direction, while the rows R1˜Rm are arranged in a Y direction. Hence, the columns C1˜Cn may be referred to as vertical columns, while the rows R1˜Rm may be referred to as horizontal rows. However, the invention is not limited thereto. According to another embodiment of the invention, the columns C1˜Cn are arranged in the Y direction, while the rows R1˜Rm are arranged in the X direction. That is to say, the columns C1˜Cn and the rows R1˜Rm described herein mainly serve to explain relative positions of arrays but do not serve to limit the invention. Hence, the positions of the columns C1˜Cn and the rows R1˜Rm may be exchanged. Besides, when the positions of the columns C1˜Cn and the rows R1˜Rm shown in FIG. 2 are exchanged, the new array arrangement refers to the old arrangement rotated by 90 degrees.

According to the present embodiment, the transparent sub-pixel T of the first pixel group G1 is located in the fourth column C4 and the first row R1, and the transparent sub-pixel T of the third pixel group G3 is located in the fifth column C5 and the second row R2. Accordingly, the transparent sub-pixel T of the first pixel group G1 and the transparent sub-pixel T of the third pixel group G3 are arranged in the different columns. Besides, the transparent sub-pixel T of the second pixel group G2 is located in the fifth column C5 and the first row R1, and the transparent sub-pixel T of the fourth pixel group G4 is located in the sixth column C6 and the second row R2. Hence, the transparent sub-pixel T of the second pixel group G2 and the transparent sub-pixel T of the fourth pixel group G4 are arranged in the different columns.

In the embodiment shown in FIG. 2, a location of the transparent sub-pixel T of the first pixel group G1 (in the fourth column C4 and the first row R1) differs from a location of the transparent sub-pixel T of the third pixel group G3 (in the fifth column C5 and the second row R2) by one column; a location of the transparent sub-pixel T of the second pixel group G2 (in the fifth column C5 and the first row R1) differs from a location of the transparent sub-pixel T of the fourth pixel group G4 (in the sixth column C6 and the second row R2) by one column. As such, the transparent sub-pixel T of the second pixel group G2 (in the fifth column C5 and the first row R1) and the transparent sub-pixel T of the third pixel group G3 (in the fifth column C5 and the second row R2) are located in the same column. It should be mentioned that the location of the transparent sub-pixel T of the first pixel group G1 may differ from the location of the transparent sub-pixel T of the third pixel group G3 by more than one column, which should not be construed as a limitation to the invention.

According to the present embodiment, the transparent sub-pixel T of the first pixel group G1 and the transparent sub-pixel G of the third pixel group G3 are arranged in different columns, and the transparent sub-pixel T of the second pixel group G2 and the transparent sub-pixel T of the fourth pixel group G4 are arranged in different columns Therefore, the transparent sub-pixels T of the first, second, third, and fourth pixel groups G1˜G4 are arranged in an oblique manner. As described above, the transparent sub-pixels T of the pixel groups in the embodiment are gathered together and arranged in an oblique manner; therefore, the arrangement of the sub-pixels in the present embodiment not only can enhance transparency of the panel but also can resolve an issue of blurred background images caused by backlight light diffraction and an issue of discontinuous image display in the transparent areas (the transmittance areas).

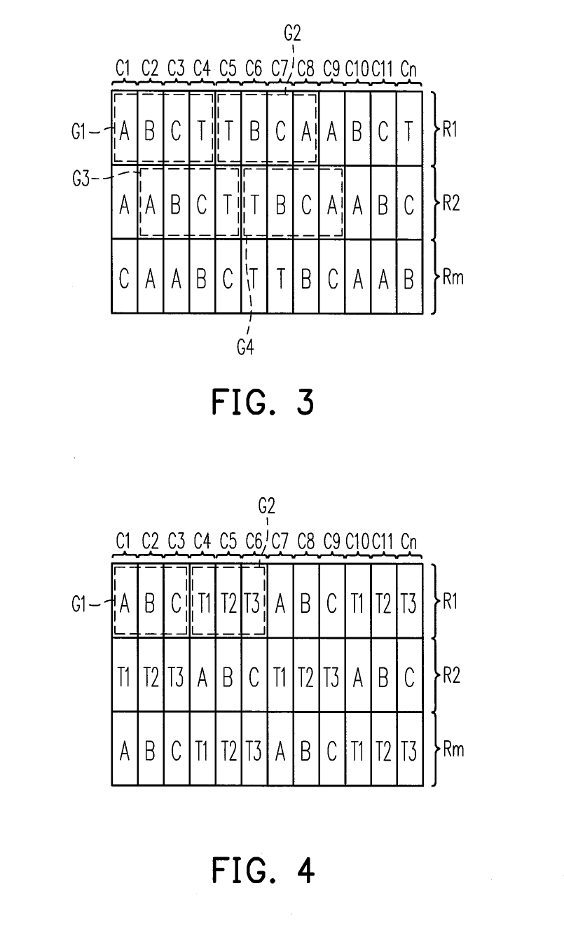

FIG. 3 is a schematic view illustrating a display panel according to an embodiment of the invention. The embodiment shown in FIG. 3 is similar to the embodiment shown in FIG. 2, and therefore identical components in FIG. 3 and FIG. 2 will be denoted with the same numerals and will not be further described hereinafter. As shown in FIG. 3, the columns C1˜Cn are arranged in an X direction, while the rows R1˜Rm are arranged in a Y direction. Therefore, the columns C1˜Cn may be referred to as vertical columns, while the rows R1˜Rm may be referred to as horizontal rows. However, the invention is not limited thereto. According to another embodiment of the invention, the columns C1˜Cn are arranged in the Y direction, while the rows R1˜Rm are arranged in the X direction. That is to say, the columns C1˜Cn and the rows R1˜Rm described herein mainly serve to explain relative positions of arrays but do not serve to limit the invention. Hence, the positions of the columns C1˜Cn and the rows R1˜Rm may be exchanged. Besides, when the positions of the columns C1˜Cn and the rows R1˜Rm shown in FIG. 3 are exchanged, the new array arrangement refers to the old arrangement rotated by 90 degrees.

According to the present embodiment, the transparent sub-pixel T of the first pixel group G1 and the transparent sub-pixel G of the third pixel group G3 are arranged in different columns (e.g., differ from each other by one column), and the transparent sub-pixel T of the second pixel group G1 and the transparent sub-pixel T of the fourth pixel group G4 are arranged in different columns (differ from each other by one column). As such, the transparent sub-pixel T of the second pixel group G2 (in the fifth column C5 and the first row R1) and the transparent sub-pixel T of the third pixel group G3 (in the fifth column C5 and the second row R2) are located in the same column. Thereby, the transparent sub-pixels T of the first, second, third, and fourth pixel groups G1˜G4 are arranged in an oblique manner. It should be mentioned that the location of the transparent sub-pixel T of the first pixel group G1 may differ from the location of the transparent sub-pixel T of the third pixel group G3 by more than one column, which should not be construed as a limitation to the invention.

The difference between the embodiment shown in FIG. 3 and the embodiment shown in FIG. 2 lies in that the arrangement of the first color sub-pixel A, the second color sub-pixel B, the third color sub-pixel C, and the transparent sub-pixel T of the first pixel group G1 and the arrangement of the first color sub-pixel A, the second color sub-pixel B, the third color sub-pixel C, and the transparent sub-pixel T of the second pixel group G2 are not symmetric in mirror. In addition, the arrangement of the first color sub-pixel A, the second color sub-pixel B, the third color sub-pixel C, and the transparent sub-pixel T of the third pixel group G3 and the arrangement of the first color sub-pixel A, the second color sub-pixel B, the third color sub-pixel C, and the transparent sub-pixel T of the fourth pixel group G4 are not symmetric in mirror. For instance, the sub-pixels of the first pixel group G1 are arranged as ABCT, while the sub-pixels of the second pixel group G2 are arranged as TBCA. Hence, the sub-pixel arrangement of the first pixel group G1 (ABCT) and the sub-pixel arrangement of the second pixel group G2 (TBCA) are not symmetric in mirror. Similarly, the sub-pixels of the third pixel group G3 are arranged as ABCT, while the sub-pixels of the fourth pixel group G4 are arranged as TBCA. Thus, the sub-pixel arrangement of the third pixel group G3 (ABCT) and the sub-pixel arrangement of the fourth pixel group G4 (TBCA) are not symmetric in mirror.

FIG. 4 is a schematic view illustrating a display panel according to an embodiment of the invention. The embodiment shown in FIG. 4 is similar to the embodiment shown in FIG. 1, and therefore identical components in FIG. 4 and FIG. 1 will be denoted with the same numerals and will not be further described hereinafter. As shown in FIG. 4, the columns C1˜Cn are arranged in an X direction, while the rows R1˜Rm are arranged in a Y direction. Hence, the columns C1˜Cn may be referred to as vertical columns, while the rows R1˜Rm may be referred to as horizontal rows. However, the invention is not limited thereto. According to another embodiment of the invention, the columns C1˜Cn are arranged in the Y direction, while the rows R1˜Rm are arranged in the X direction. That is to say, the columns C1˜Cn and the rows R1˜Rm described herein mainly serve to explain relative positions of arrays but do not serve to limit the invention. Therefore, the positions of the columns C1˜Cn and the rows R1˜Rm may be exchanged. Besides, when the positions of the columns C1˜Cn and the rows R1˜Rm shown in FIG. 4 are exchanged, the new array arrangement refers to the old arrangement rotated by 90 degrees.

In the present embodiment, the first pixel group G1 includes a first color sub-pixel A, a second color sub-pixel B, and a third color sub-pixel C. The second pixel group G2 includes a first transparent sub-pixel T1, a second transparent sub-pixel T2, and a third transparent sub-pixel T3.

According to the present embodiment, if the display panel described herein is an organic electroluminescent display panel, each of the first color sub-pixel A, the second color sub-pixel B, and the third color sub-pixel C is respectively a sub-pixel structure of the organic electroluminescent display that includes a scan line, a data line, a power line, active devices, a cathode layer, an organic light emitting layer, an anode layer, and so on. If the display panel described herein is an electrophoretic display panel, each of the first color sub-pixel A, the second color sub-pixel B, and the third color sub-pixel C is respectively a sub-pixel structure of the electrophoretic display panel that includes a scan line, a data line, an active device, a pixel electrode, an electrophoretic display layer, an opposite electrode, and so on. As described above, the type of the display panel is not limited in the invention, and therefore the first, second, and third sub-pixel structures may be adjusted based on the type of the display panel.

The first, second, and third transparent sub-pixels T1, T2, and T3 are not equipped with any display device. Therefore, the first, second, and third transparent sub-pixels T1, T2, and T3 may have metal circuits or conductive wires to transmit driving signals to the first, second, and third sub-pixels A, B, and C; alternatively, the first, second, and third transparent sub-pixels T1, T2, and T3 may have no circuit, which should not be construed as a limitation to the invention. Since there is no display device in the first, second, and third transparent sub-pixels T1, T2, and T3, the first, second, and third transparent sub-pixels T1, T2, and T3 of the second pixel group G2 have great transparency or transmittance properties.

As described above, the first pixel group G1 (sub-pixels of the display image) and the second pixel group G2 (transparent sub-pixels) in the display panel of this embodiment are arranged in a checkerboard-shaped manner. When the display panel is off, the transparent sub-pixels of the second pixel group G2 may ensure transparency of the display panel, such that a user is able to observe the background image behind the display panel.

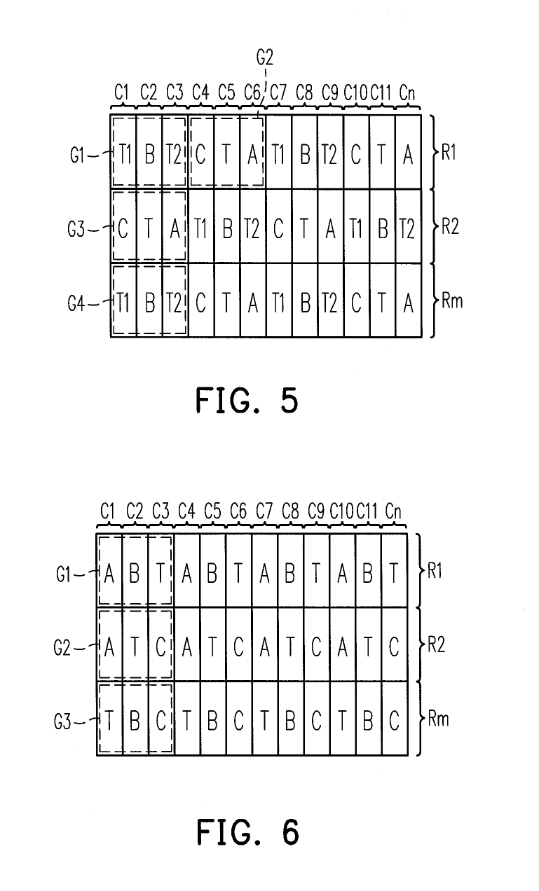

FIG. 5 is a schematic view illustrating a display panel according to an embodiment of the invention. The embodiment shown in FIG. 5 is similar to the embodiment shown in FIG. 1, and therefore identical components in FIG. 5 and FIG. 1 will be denoted with the same numerals and will not be further described hereinafter. As shown in FIG. 5, the columns C1˜Cn are arranged in an X direction, while the rows R1˜Rm are arranged in a Y direction. Hence, the columns C1˜Cn may be referred to as vertical columns, while the rows R1˜Rm may be referred to as horizontal rows. However, the invention is not limited thereto. According to another embodiment of the invention, the columns C1˜Cn are arranged in the Y direction, while the rows R1˜Rm are arranged in the X direction. That is to say, the columns C1˜Cn and the rows R1˜Rm described herein mainly serve to explain relative positions of arrays but do not serve to limit the invention. Accordingly, the positions of the columns C1˜Cn and the rows R1˜Rm may be exchanged. Besides, when the positions of the columns C1˜Cn and the rows R1˜Rm shown in FIG. 5 are exchanged, the new array arrangement refers to the old arrangement rotated by 90 degrees.

According to the present embodiment, the display panel includes a first pixel group G1 and a second pixel group G2 which are arranged in the first row R1 and are adjacent to each other. The first pixel group G1 includes a first transparent sub-pixel T1, a second color sub-pixel B, and a second transparent sub-pixel T2. The second pixel group G2 includes a first color sub-pixel A, a transparent sub-pixel T, and a third color sub-pixel C.

Similarly, the first color sub-pixel A, the second color sub-pixel B, and the third color sub-pixel C mainly serve to display images, and thus the first color sub-pixel A, the second color sub-pixel B, and the third color sub-pixel C have corresponding signal lines, active devices, display media, and other devices according to the type of the display panel. The first transparent sub-pixel T1, the second transparent sub-pixel T2, and the transparent sub-pixel T are not equipped with any display device. Therefore, the first transparent sub-pixel T1, the second transparent sub-pixel T2, and the transparent sub-pixel T may have metal circuits or conductive wires to transmit driving signals to the first, second, and third sub-pixels A, B, and C; alternatively, the first transparent sub-pixel T1, the second transparent sub-pixel T2, and the transparent sub-pixel T may have no circuit, which should not be construed as a limitation to the invention. Since there is no display device in the first transparent sub-pixel T1, the second transparent sub-pixel T2, and the transparent sub-pixel T, the first transparent sub-pixel T1, the second transparent sub-pixel T2, and the transparent sub-pixel T have great transparency or transmittance properties.

To be more specific, in the first pixel group G1, the first transparent sub-pixel T1 is located in the first column C1 and the first row R1, the second color sub-pixel B is located in the second column C2 and the first row R1, and the second transparent sub-pixel T2 is located in the third column C3 and the first row R1. Hence, the sub-pixels of the first pixel group G1 are arranged as T1-B-T2. In the second pixel group G2, the third color sub-pixel C is located in the fourth column C4 and the first row R1, the transparent sub-pixel T is located in the fifth column C5 and the first row R1, and the first color sub-pixel A is located in the sixth column C6 and the first row R1. Thus, the sub-pixels of the second pixel group G2 are arranged as C-T-A. The display panel of the present embodiment is constituted by the first pixel groups G1 and the second pixel groups G2, and the first and second pixel groups G1 and G2 are alternately arranged in a checkerboard-shaped manner.

If a pixel group that is adjacent to the first pixel group G1 and arranged in the second row R2 is defined as the third pixel group G3, the third pixel group G3 includes a first color sub-pixel A, a transparent sub-pixel T, and a third color sub-pixel C. Particularly, in the third pixel group G3, the third color sub-pixel C is located in the first column C1 and the second row R2, the transparent sub-pixel T is located in the second column C2 and the second row R2, and the first color sub-pixel A is located in the third column C3 and the second row R2. Hence, the sub-pixels of the third pixel group G3 are arranged as C-T-A. That is to say, the sub-pixel arrangement of the third pixel group G3 is the same as the sub-pixel arrangement of the second pixel group G2.

If a pixel group that is adjacent to the third pixel group G3 and arranged in the third row R3 is defined as the fourth pixel group G4, the fourth pixel group G4 includes a first transparent sub-pixel T1, a second color sub-pixel B, and a second transparent sub-pixel T2. To be more specific, in the fourth pixel group G4, the first transparent sub-pixel T1 is located in the first column C1 and the third row R3, the second color sub-pixel B is located in the second column C2 and the third row R3, and the second transparent sub-pixel T2 is located in the third column C3 and the third row R3. Hence, the sub-pixels of the fourth pixel group G4 are arranged as T1-B-T2. That is to say, the sub-pixel arrangement of the fourth pixel group G4 is the same as the sub-pixel arrangement of the first pixel group G1.

In the display panel of the present embodiment, the second color sub-pixel B (e.g., a green sub-pixel) of the first pixel group G1 and the second color sub-pixel B (e.g., a green sub-pixel) of the fourth pixel group G4 are located at two opposite sides of the transparent sub-pixel T of the third pixel group G3. The first color sub-pixel A (e.g., a red sub-pixel) and the third color sub-pixel C (e.g., a green-blue sub-pixel) are located at the other two opposite sides of the transparent sub-pixel T of the third pixel group G3.

Note that when the display panel displays images, the second color sub-pixel B (e.g., a green sub-pixel) of the first pixel group G1 and the second color sub-pixel B (e.g., a green sub-pixel) of the fourth pixel group G4 are able to perform a color-complementing function on the transparent sub-pixel T of the third pixel group G3, such that the transparent sub-pixel T of the third pixel group G3 has the second color (e.g., green), and that the resolution of the display panel can consistently have a certain value. In addition, when the display panel is off, the first/second transparent sub-pixel T1/T2 and the transparent sub-pixel T may ensure transparency of the display panel, such that a user is able to observe the background image behind the display panel.

FIG. 6 is a schematic view illustrating a display panel according to an embodiment of the invention. The embodiment shown in FIG. 6 is similar to the embodiment shown in FIG. 1, and therefore identical components in FIG. 6 and FIG. 1 will be denoted with the same numerals and will not be further described hereinafter. As shown in FIG. 6, the columns C1˜Cn are arranged in an X direction, while the rows R1˜Rm are arranged in a Y direction. Hence, the columns C1˜Cn may be referred to as vertical columns, while the rows R1˜Rm may be referred to as horizontal rows. However, the invention is not limited thereto. According to another embodiment of the invention, the columns C1˜Cn are arranged in the Y direction, while the rows R1˜Rm are arranged in the X direction. That is to say, the columns C1˜Cn and the rows R1˜Rm described herein mainly serve to explain relative positions of arrays but do not serve to limit the invention. Therefore, the positions of the columns C1˜Cn and the rows R1˜Rm may be exchanged. Besides, when the positions of the columns C1˜Cn and the rows R1˜Rm shown in FIG. 6 are exchanged, the new array arrangement refers to the old arrangement rotated by 90 degrees.

In the present embodiment, the display panel includes a first pixel group G1, a second pixel group G2, and a third pixel group G3.

The first pixel group G1 is arranged in the first row R1 and includes a first color sub-pixel A, a second color sub-pixel B, and a transparent sub-pixel T. To be more specific, in the first pixel group G1, the first color sub-pixel A is located in the first column C1 and the first row R1, the second color sub-pixel B is located in the second column C2 and the first row R1, and the transparent sub-pixel T is located in the third column C3 and the first row R1. Hence, the sub-pixels of the first pixel group G1 are arranged as ABT.

The second pixel group G2 is adjacent to the first pixel group G1 and arranged in the second row R2. Besides, the second pixel group G2 includes a first color sub-pixel A, a transparent sub-pixel T, and a third color sub-pixel C. Particularly, in the second pixel group G2, the first color sub-pixel A is located in the first column C1 and the second row R2, the transparent sub-pixel T is located in the second column C2 and the second row R2, and the third color sub-pixel C is located in the third column C3 and the second row R2. Hence, the sub-pixels of the second pixel group G2 are arranged as ATC.

The third pixel group G3 is adjacent to the second pixel group G2 and arranged in the third row R3. Besides, the third pixel group G3 includes a transparent sub-pixel T, a second color sub-pixel B, and a third color sub-pixel C. To be more specific, in the third pixel group G3, the transparent sub-pixel T is located in the first column C1 and the third row R3, the second color sub-pixel B is located in the second column C2 and the third row R3, and the third color sub-pixel C is located in the third column C3 and the third row R3. Hence, the sub-pixels of the third pixel group G3 are arranged as TBC.

In the display panel of the present embodiment, the second color sub-pixel B (e.g., a green sub-pixel) of the first pixel group G1 and the second color sub-pixel B (e.g., a green sub-pixel) of the third pixel group G3 are located at two opposite sides of the transparent sub-pixel T of the second pixel group G2. The first color sub-pixel A (e.g., a red sub-pixel) and the third color sub-pixel C (e.g., a green-blue sub-pixel) are located at the other two opposite sides of the transparent sub-pixel T of the second pixel group G2.

Note that when the display panel displays images, the second color sub-pixel B (e.g., a green sub-pixel) of the first pixel group G1 and the second color sub-pixel B (e.g., a green sub-pixel) of the third pixel group G3 are able to perform a color-complementing function on the transparent sub-pixel T of the second pixel group G2, such that the transparent sub-pixel T of the second pixel group G2 has the second color (e.g., green), and that the resolution of the display panel can consistently have a certain value. When the display panel is off, the transparent sub-pixels T of the first, second, and third pixel groups G1-G3 may ensure transparency of the display panel, such that a user is able to observe the background image behind the display panel.

In light of the foregoing, the design of the transparent sub-pixel allows the display panel to have the transmittance properties when the display panel is off. The first, second, and third color pixels of the display panel serve to display images, and the transparent sub-pixel mainly serves to ensure transparency of the display panel. Hence, the display panel of the invention can have optimal display quality and can have certain transparency. From another perspective, the arrangement of the first, second, and third color sub-pixels and the transparent sub-pixel, the resolution of the display panel can consistently have a certain value.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A display panel having a pixel array arranged with a plurality of columns and a plurality of rows, wherein the columns are arranged along an X direction, and the rows are arranged along a Y direction, or the columns are arranged along the Y direction, and the rows are arranged along the X direction, the display panel comprising:
a first pixel group and a second pixel group arranged in a first row of the rows and adjacent to each other, wherein
each of the first pixel group and the second pixel group respectively comprises a first color sub-pixel, a second color sub-pixel, a third color sub-pixel, and a transparent sub-pixel, and
arrangement of the first color sub-pixel, the second color sub-pixel, the third color sub-pixel, and the transparent sub-pixel of the first pixel group and arrangement of the first color sub-pixel, the second color sub-pixel, the third color sub-pixel, and the transparent sub-pixel of the second pixel group are symmetric in mirror.

2. The display panel as recited in claim 1, further comprising a third pixel group and a fourth pixel group arranged in a second row of the rows, wherein
each of the third pixel group and the fourth pixel group comprises a first color sub-pixel, a second color sub-pixel, a third color sub-pixel, and a transparent sub-pixel, and
arrangement of the first color sub-pixel, the second color sub-pixel, the third color sub-pixel, and the transparent sub-pixel of the third pixel group and arrangement of the first color sub-pixel, the second color sub-pixel, the third color sub-pixel, and the transparent sub-pixel of the fourth pixel group are symmetric in mirror.

3. The display panel as recited in claim 2, wherein the transparent sub-pixel of the first pixel group and the transparent sub-pixel of the third pixel group are arranged in one of the columns, and the transparent sub-pixel of the second pixel group and the transparent sub-pixel of the fourth pixel group are arranged in one of the columns.

4. The display panel as recited in claim 2, wherein the transparent sub-pixel of the first pixel group and the transparent sub-pixel of the third pixel group are arranged in different columns, and the transparent sub-pixel of the second pixel group and the transparent sub-pixel of the fourth pixel group are arranged in different columns.

5. The display panel as recited in claim 4, wherein a location of the transparent sub-pixel of the first pixel group differs from a location of the transparent sub-pixel of the third pixel group by one column, and a location of the transparent sub-pixel of the second pixel group differs from a location of the transparent sub-pixel of the fourth pixel group by one column.

6. The display panel as recited in claim 5, wherein the transparent sub-pixel of the second pixel group and the transparent sub-pixel of the third pixel group are located in one of the columns.

7. A display panel having a plurality of columns and a plurality of rows, wherein the columns are arranged along an X direction, and the rows are arranged along a Y direction, or the columns are arranged along the Y direction, and the rows are arranged along the X direction, the display panel comprising:
a first pixel group and a second pixel group arranged in a first row of the rows and adjacent to each other; and
a third pixel group and a fourth pixel group arranged in a second row of the rows and adjacent to each other, wherein
each of the first pixel group, the second pixel group, the third pixel group, and the fourth pixel group comprises a first color sub-pixel, a second color sub-pixel, a third color sub-pixel, and a transparent sub-pixel, and
the transparent sub-pixel of the first pixel group and the transparent sub-pixel of the third pixel group are located in different columns, and the transparent sub-pixel of the second pixel group and the transparent sub-pixel of the fourth pixel group are located in different columns.

8. The display panel as recited in claim 7, wherein a location of the transparent sub-pixel of the first pixel group differs from a location of the transparent sub-pixel of the third pixel group by one column, and a location of the transparent sub-pixel of the second pixel group differs from a location of the transparent sub-pixel of the fourth pixel group by one column.

9. The display panel as recited in claim 8, wherein the transparent sub-pixel of the second pixel group and the transparent sub-pixel of the third pixel group are located in one of the columns.

10. A display panel comprising:
a plurality of first pixel groups, each of the first pixel groups comprising a first color sub-pixel, a second color sub-pixel, and a third color sub-pixel; and
a plurality of second pixel groups, each of the second pixel groups comprising a first transparent sub-pixel, a second transparent sub-pixel, and a third transparent sub-pixel, wherein
the first pixel groups and the second pixel groups are arranged in a checkerboard-shaped manner.

11. A display panel having a plurality of columns and a plurality of rows, wherein the columns are arranged along an X direction, and the rows are arranged along a Y direction, or the columns are arranged along the Y direction, and the rows are arranged along the X direction, the display panel comprising:
a first pixel group arranged in a first row of the rows and comprising a first transparent sub-pixel, a second color sub-pixel, and a second transparent sub-pixel; and
a second pixel group adjacent to the first pixel group and arranged in the first row, the second pixel group comprising a first color sub-pixel, a transparent sub-pixel, and a third color sub-pixel.

12. The display panel as recited in claim 11, further comprising:
a third pixel group adjacent to the first pixel group and arranged in a second row of the rows, the third pixel group comprising a first color sub-pixel, a transparent sub-pixel, and a third color sub-pixel; and
a fourth pixel group adjacent to the third pixel group and arranged in a third row of the rows, the fourth pixel group comprising a first transparent sub-pixel, a second color sub-pixel, and a second transparent sub-pixel.

13. The display panel as recited in claim 12, wherein the second color sub-pixel of the first pixel group and the second color sub-pixel of the fourth pixel group are located at two opposite sides of the transparent sub-pixel of the third pixel group.

14. A display panel having a pixel array arranged with a plurality of columns and a plurality of rows, wherein the columns are arranged along an X direction, and the rows are arranged along a Y direction, or the columns are arranged along the Y direction, and the rows are arranged along the X direction, the display panel comprising:
a first pixel group arranged in a first row of the rows and comprising a first color sub-pixel, a second color sub-pixel, and a transparent sub-pixel;
a second pixel group adjacent to the first pixel group and arranged in a second row of the rows, the second pixel group comprising a first color sub-pixel, a transparent sub-pixel, and a third color sub-pixel; and
a third pixel group adjacent to the second pixel group and arranged in a third row of the rows, the third pixel group comprising a transparent sub-pixel, a second color sub-pixel, and a third color sub-pixel.

15. The display panel as recited in claim 14, wherein the second color sub-pixel of the first pixel group and the second color sub-pixel of the third pixel group are located at two opposite sides of the transparent sub-pixel of the second pixel group.
